(19) United States
(12) Patent Application Publication
(10) Pub. No.: US 2022/0117419 A1
(43) Pub. Date: Apr. 21, 2022

(54) SYSTEM AND METHOD FOR CUSTOMIZABLE AND REUSABLE CELEBRATION DEVICE

(71) Applicant: Timothy J. McGuire, Sussex, WI (US)

(72) Inventor: Timothy J. McGuire, Sussex, WI (US)

(21) Appl. No.: 17/075,287

(22) Filed: Oct. 20, 2020

(51) Int. Cl. A47G 19/26

(52) U.S. Cl. CPC A47G 19/26

(57) ABSTRACT

A cover is positioned over a base unit and a first candle is inserted through a perforation formed in the cover and into a first apertured formed in the base unit. The cover is rotated around the candle to position the cover such that additional perforations in the cover are aligned with additional apertures in the base. The cover can also be rotated to align an alignment marker on the cover with an alignment marker on the top surface of the base unit. Additional candles can then be inserted through the perforations in the cover and into additional apertures in the base. The candles can then be lit. After the candles are extinguished (e.g., blown out the by birthday celebrant), the candles can be removed from the apertures in the base and through the perforations in the cover.

### BACKGROUND OF THE INVENTION

The present disclosure is directed to a system and method for a reusable and customizable device used in connection with celebrations such as birthday parties.

### BACKGROUND

The use of candles inserted into the top of a cake or other food item have traditionally been used in connection with celebrating special events such as birthdays. Having the person celebrating a birthday blow out the candles on a birthday cake is a common way to celebrate a birthday. The hygiene associated with blowing out the candles on a cake or other food item has become an increasing concern. As one example, there are concerns that the person blowing out the candles might transmit a virus or other pathogen that can cause illness onto the surface of the cake. This pathogen could then be passed on to the people that eat or otherwise come in contact the cake. There exists a continuing need in the marketplace for a device that can be used to hold candles in connection with a celebration that is customizable and optionally reusable.

### SUMMARY

In one aspect, a cover is positioned over a base unit and a first candle is inserted through a perforation formed in the cover and into a first apertured formed in the base unit. Alternatively, a candle can be placed into an aperture formed in the base unit, and a cover can then be positioned above the base unit and candle and then lowered to permit the candle to pierce through an aperture in the cover as the cover is lowered to the surface of the base unit. The cover is rotated around the candle to position the cover such that additional perforations in the cover are aligned with additional apertures in the base. The cover can also be rotated to align an alignment marker on the cover with an alignment marker on the top surface of the base unit. Additional candles can then be inserted through the perforations in the cover and into additional apertures in the base. The candles can then be lit. After the candles are extinguished (e.g., blown out the by birthday celebrant or person celebrating another milestone such as a wedding anniversary or retirement), the candles can be removed from the apertures in the base and through the perforations in the cover. The cover can be removed from the base. The cover can be cleaned before or after removal from the base. The cover can be stored and then reused again for other events. The cover can also optionally be affixed to a smooth surface such as a mirror or window for decoration.

### BRIEF DESCRIPTION OF THE DRAWINGS

FIG. 1 depicts an exemplary embodiment of the cover and base of the present application.

FIG. 2 depicts an exemplary embodiment of the cover of the present application.

FIG. 3 depicts an exemplary embodiment of the base of the present application.

FIG. 4 depicts an exemplary embodiment of the cover positioned upon with base with candles inserted into the base.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

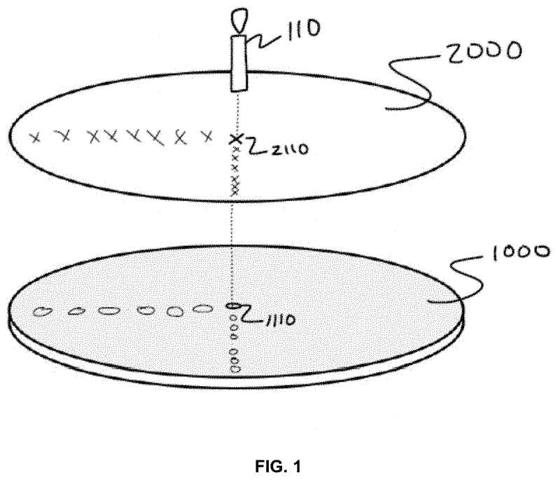

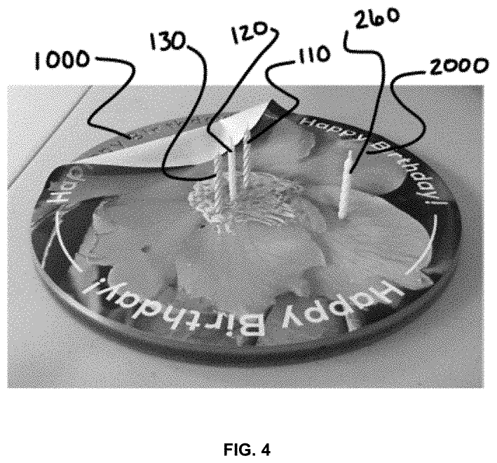

Referring to FIGS. 1, 2, 3, and 4 according to one aspect the present application includes a base 1000 and cover 2000. Base 1000 is typically a structure that includes apertures such as apertures 1110, 1120, and 1130 to receive candles such as candles 110, 120, and 130. With reference to FIG. 4, a portion of cover 2000 is folded over itself to expose a portion of the surface of base 1000. The diameters of the apertures such as apertures 1110, 1120, and 1130 are typically sized to permit the reception into the apertures of a candle such as candles 110, 120, and 130. A typical birthday candle has a diameter of approximately 0.20 inches. Accordingly, in one aspect, the diameter of apertures such as apertures 1110 and 1120 in base 1000 can be at least 0.20 inches in diameter and may be approximately 0.30 in diameter to permit easier insertion and removal of candles into the aperture. The diameters of the apertures can likewise be sized to receive candles of other diameters as well. In one aspect as shown in FIGS. 1, 3, and 4, base 1000 is circular in shape. In another aspect base 1000 can have a diameter of 12.0 inches, but any other size and shape not inconsistent with the present application can be used. In another aspect, base 1000 is constructed from wood with a sealed finish. In one embodiment, base 1000 can be constructed from pressboard that is sealed with an osmo hard wax oil. In other aspects, paint or other clear sealants can be used to cover the pressboard. Base 1000 can likewise be constructed from other materials such as wood, plywood, plastics, and other polymers that are not inconsistent with the present application.

In another aspect and with reference to FIGS. 1, 2, 3, and 4, a candle such as candle 110 is placed in an aperture 1110 in base 1000. Cover 2000 is then positioned over base 1000 such that candle 110 is vertically aligned with perforation 2110 in cover 2000. The cover is then lowered such that candle 110 pierces perforation 2110 and extends through cover 2000 as cover is lowered towards base 1000. Cover 2000 can then be rotated to match an alignment marker 2200 in cover 2000 with alignment marker 1100 in base 1000. Other techniques, including those described below, can also be used to align cover 2000 in relation to base 1000.

In another aspect, cover 2000 is typically removably placed over the surface 1200 of base 1000. Cover 2000 is typically constructed from a pliable material such as vinyl. In another aspect, static cling resulting from static electricity between cover 2000 and base 1000 can further enable cover 2000 to be removably affixed to base 1000. Cover 2000 typically includes text and images suitable for an event to be celebrated such as a birthday. Cover 2000 is typically constructed from a material suitable to have text and images printed upon it. Cover 2000 also is typically constructed from a material that is not damaged by melted candle wax that may drip onto cover 2000 when the present application is in use. In a preferred embodiment, cover 2000 can be constructed from white gloss static cling vinyl, available as CONCEPT® 208 from General Formulations in Sparta, Mich. In another preferred embodiment, cover 2000 can be constructed from clear gloss static cling vinyl, available as CONCEPT® 207 from General Formulations in Sparta, Mich. Cover 2000 can also be constructed from other materials having properties that are not inconsistent with the present application.

Cover 2000 typically includes candle reception areas such as perforations 2110, 2120, and 2130 typically positioned in cover 2000 to correspond to the apertures in base 1000 such as apertures 1110, 1120, and 1130 when cover 2000 is properly oriented in relation to cover 1000. The length of the incisions (e.g., incisions 2122 and 2124) made in cover 2000 to form perforations such as perforation 2120 can be sized to permit the insertion of a candle into the apertures in base 1000. As noted above, the diameter of a typical birthday cancel can be 0.20 inches. Accordingly, the length of the incisions (e.g., incisions 2122 and 2124) made in cover 2000 to form perforations such as perforation 2120 can be at least 0.20 inches long and can be 0.25 inches in length. In another aspect, the incisions made to form a perforation in cover 2000 such as incisions 2122 and 2124 are typically at right angles to one another. In another aspect, cover 2000 typically includes an alignment marker 2200 that can be used in conjunction with alignment marker 1100 in base 1000.

In another aspect, cover 2000 can be properly aligned with base 1000 by first positioning cover 2000 over base 1000 such that the center perforation 2110 is positioned over the center aperture 1110 in base 1000 as shown in FIG. 1. A candle 110 can be inserted through center perforation 2110 and into center aperture 1110. Cover 2000 can then be rotated about candle to align the perforations 2120 and 2130 with apertures 1120 and 1130. In another aspect, cover 2000 can also be rotated about candle 100 to position alignment marker 2200 into alignment with alignment marker 1100. Additional candles such as candles 120 and 130 can then be inserted through perforations in the cover 2000 such as perforations 2120 and 2130 and into apertures in base 1000 such as apertures 1120 and 1130, which are positioned proximate perforations 2120 and 2130 when cover 2000 is in proper alignment with base 1000. Additional candles such as candles such as candle 260 can also be inserted through additional perforations in cover 2000 into apertures positioned below these perforations. The pattern of perforations 2110, 2120, and 2130 and apertures 1110, 1120, and 1130 shown in FIGS. 1, 2, 3, and 4 is by way of example only.

In the embodiment shown in FIGS. 1, 2, 3, and 4, the pattern of the perforations and apertures is radial and extending from the center of the cover 2000 and base 1000. This pattern is also symmetrical, which makes positioning the cover 2000 over 1000 easier because once candle 100 is inserted through the center perforation 2110 and into center aperture 1110, the remaining perforations in cover 2000 can be aligned with the apertures in cover 1000 by rotating cover 2000 such that any other perforation aligns with another aperture.

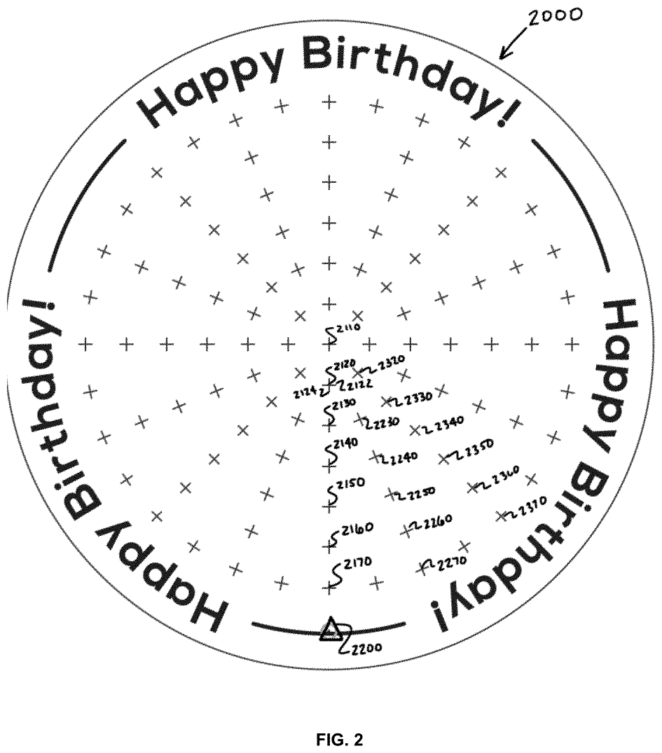

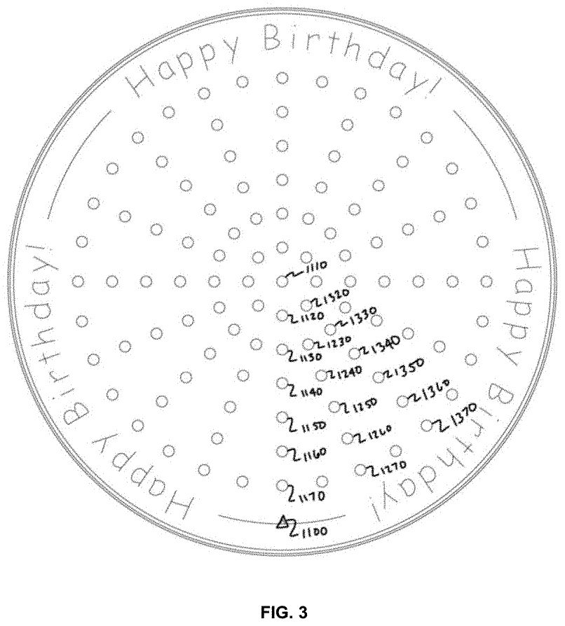

As shown in FIGS. 2 and 3, each radial line of perforations extending from the center perforation 2110 (e.g., perforations 2120, 2130, 2140, 2150, 2160, and 2170) has an equal radial angle from an adjacent radial perforation line. For example, the radial line formed by perforations 2110, 2120, 2130 is at an angle of 22.5 degrees from the adjacent radial perforation line formed by perforations 2110, 2230, 2240, 2250, 2260, and 2270. The next adjacent radial perforation line formed by perforations 2110, 2320, 2030, 2340, 2350, 2360, and 2370 is likewise at an angle of 22.5 to the radial perforation line formed by perforations 2110, 2230, 2240, 2250, 2260, and 2270. As shown in FIG. 2, all of the radial perforation lines are at an angle of 22.5 to an adjacent line. In this aspect, the geometry of the apertures in base 1000 matches the geometry of the perforations in cover 2000. For example, the geometry of apertures 1110, 1120, 1130, 1140, 1150, 1160, and 1170 corresponds to the geometry of perforations 2110, 2230, 2240, 2250, 2260, and 2270. Many other patterns for the perforations and apertures can be used. When selecting these additional patterns, it is preferable that the perforations are positioned over the apertures when the cover 2000 is properly aligned over the base 1000.

In another aspect, cover 2000 can be constructed by selecting digital images such as those available from royalty-free sources such as Vecteezy.com and upsplash.com. These images can then be assembled and clipped into circles on a template. Text can also be optionally colored and added using applications such as Nexa Light and Nexa Bold available from fontfabric (www.fontfabric.com). These designs can then be placed into a file for printing. In one aspect, four (4) disks are placed in a row when, for example, the maximum width that can be cut is forty-nine (49) inches. A length of ten (10) feet per sheet is typically used to print and cut the material, which results in nine (9) rows and thirty-six (36) discs per sheet with appropriate spacing. General Formulations Concept 208 Static Cling can be used for opaque designs and General Formulations Concept 207 can be used for clear designs. The covers 2000, or disks, are typically printed on the appropriate material using an HP Latex 310 printer with print profiles that have been optimized for the project. The print is then typically loaded onto a Graphtec Series 8600 cutter, and an optimized blade condition for the material is selected. The disks are then contour cut. After being contour cut, the disks are typically cut apart either by hand or by perforation cut on a Graphtec 8600 cutter and then manually pulled apart at the perforations.

Following is a nonlimiting example of how the present application can be used. A user removes a protective film (not shown) from cover 2000 and positions cover 2000 over base 1000 such that perforation 2110 is aligned vertically over aperture 1110 base 1000. A candle is then inserted through perforation 2110 and into aperture 1100. In another aspect, candle 110 can first be positioned in aperture 1110, and cover 2000 is then lowered towards base 1000 such that candle 110 pierces through perforation 2110 as cover 2000 is lowered towards base 1000. Cover 1000 is then rotated so that alignment marker 2200 on cover 2000 is positioned in vertical alignment with alignment marker 1100 on cover 1000. Cover 1000 can also be rotated such that alignment marker 2200 is positioned proximate alignment marker 1100. Additional candles such as candles 120 and 130 can then be inserted through perforations in cover 2000 such as perforations 2120 and 2130 and then inserted into apertures in base 1000 such as apertures 1120 and 1130. Once all of the desired candles are inserted through the perforations and into the apertures, the candles can be lit in connection with celebrating an event such as a birthday, wedding anniversary, retirement, or other milestone.

Once the candles are extinguished, the candles can be removed from the apertures and perforations. Cover 2000 can then be removed from base 1000 typically by grasping an edge of cover 2000 and then peeling cover 2000 away from base 1000. Any melted candle wax that has dripped onto cover 2000 can typically be removed from cover 2000 by gently bending and partially folder cover such that the melted candle wax flakes away from cover 2000. As another option, cover 2000 typically can be washed with a detergent such as dish soap either before or after cover 2000 is removed from base 1000. Cover 2000 can typically be stored and re-used multiple times. In other aspects, cover 2000 can be presented to the person whose event is being celebrated (e.g., a birthday) so that the person can use cover 2000 as a decoration. For example, a could removable affix cover 2000 onto the surface of a mirror, window, or other smooth surface. Cover 2000 will typically adhere to such smooth surfaces through static cling.

In another aspect, custom covers 2000 can be created using a variety of options. In one aspect, a user can upload an image to a website, make edits and other customizations to the image, and then optionally add a message onto the image. The customized image can then be sized to fit on a cover 2000 that will be printed and sent to the user. In other aspect, a user can use a website to select from various image options available on a website and then add a custom message to the selected image. This image can then be sized to fit on a cover 2000 that will be printed and sent to the user.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems, and method steps. It is to be expected that various equivalents, alternatives, and modifications are possible within the scope of the appended claims.

What is claimed is:

1. A method for decorating an item, comprising:
positioning a cover above a base structure;
inserting a first candle into a first aperture formed in the base structure;
rotating the cover to align a second candle reception area formed in the cover with a second aperture formed in the base structure;
releasably affixing the cover to the base structure;
inserting a second candle through the second candle reception area formed in the cover and into the second aperture formed in the base structure; and
removing the cover from the base structure.

2. The method of claim 1, wherein the first candle is inserted through a first reception area formed in the cover after the first candle has been inserted into the first aperture formed in the base structure.

3. The method of claim 1, wherein the first candle is inserted through a first reception area in the cover after the cover has been positioned proximate a surface of the base unit.

4. The method of claim 1, wherein the first candle reception area is formed by a first perforation formed in the cover.

5. The method of claim 4, wherein the first perforation is formed by a first incision made in the cover that intersects with a second incision made in the cover.

6. The method of claim 5, wherein the length of the first incision is at least equal to a diameter of the candle.

7. The method of claim 5, wherein the first incision is formed at a right angle to the second incision.

8. The method of claim 1, wherein the second candle reception area is formed by a second perforation formed in the cover.

9. The method of claim 1, wherein the cover is composed of vinyl.

10. The method of claim 1, wherein the cover includes an image selected by a user.

11. The method of claim 1, wherein the cover includes a cover alignment marker, and the base includes a base alignment marker.

12. The method of claim 1, wherein a first radial angle between a reference line of apertures extending radially from the center of the base structure and a first line of apertures extending radially from the center of the base structure and adjacent to the reference line of apertures is equal to a second radial angle between the reference line of apertures and a second line of apertures extending radially from the center of the base structure and adjacent to the reference line of apertures on the side opposite the first line of apertures.

13. The method of claim 1, wherein a pattern of apertures formed in the base unit matches a pattern of reception areas formed in the cover.

14. A method for decorating an item, comprising:
positioning a vinyl cover proximate a surface of a wooden base unit, wherein the vinyl cover includes an image selected by a user;
inserting a first candle into a first aperture formed in the base unit;
inserting the first candle through a first perforation formed in the cover;
rotating the cover to align a second perforation formed in the cover with a second aperture formed in the base unit and to align a first alignment marker on the cover with a second alignment marker on a top surface of the base unit;
releasably affixing the cover to the base unit;
inserting a second candle through a perforation formed in the cover and into a second aperture formed in the base unit; and
removing the cover from the base structure.

15. The method of claim 14, wherein the first candle is inserted through the first perforation formed in the cover after the first candle has been inserted into the first aperture formed in the base structure.

16. The method of claim 14, wherein the first candle is inserted through the first perforation after the cover has been positioned proximate the surface of the base structure.

17. The method of claim 14, further comprising the step of reusing the cover on the base unit.

18. The method of claim 14, further comprising the step of affixing the cover to a smooth surface to use the cover as a decoration.

19. The method of claim 14, wherein a first radial angle between a reference line of apertures extending radially from the center of the base structure and a first line of apertures extending radially from the center of the base structure and adjacent to the reference line of apertures is equal to a second radial angle between the reference line of apertures and a second line of apertures extending radially from the center of the base structure and adjacent to the reference line of apertures on the side opposite the first line of apertures.

20. The method of claim 14, wherein a pattern of apertures formed in the base unit matches a pattern of perforations formed in the cover.
